(19) United States
(12) Patent Application Publication
(10) Pub. No.: US 2023/0249907 A1
(43) Pub. Date: Aug. 10, 2023

(54) REFUSE COLLECTION VEHICLE

(71) Applicant: The Heil Co., Chattanooga, TN (US)

(72) Inventors: Stanley L. Maroney, Attalla, AL (US); Tapankumar Pandya, Ooltewah, TN (US); Douglas Michael Anders, New Market, AL (US); Brian T. Parker, Signal Mountain, TN (US)

(21) Appl. No.: 18/163,075

(22) Filed: Feb. 1, 2023

Related U.S. Application Data
(60) Provisional application No. 63/306,598, filed on Feb. 4, 2022.

(51) Int. Cl. B65F 3/14; B65F 3/04; H01M 50/204; H01M 50/249; B60L 50/60; B60L 1/00; B60K 1/04

(52) U.S. Cl. CPC B65F 3/14; B65F 3/04; H01M 50/204; H01M 50/249; B60L 50/60; B60L 1/003; B60K 1/04; B65F 2003/0279

(57) ABSTRACT

A refuse collection vehicle includes a wheeled chassis, a battery pack, a refuse collection body, and a DC-DC converter. The wheeled chassis has an electric propulsion motor connected to a road wheel of the chassis. The battery pack has multiple battery cells and provides electrical power to the propulsion motor. The refuse collection body is carried by the chassis and defines a refuse storage compartment. The refuse collection body includes a refuse packer driven by an electric packer motor. The refuse collection body also includes a powered tailgate driven by an electric tailgate motor. The DC-DC converter is connected to the battery pack and provides electrical power to the electric packer motor and to the electric tailgate motor at one or more DC voltages different than a voltage provided by the battery pack to the DC-DC converter.

### CROSS-REFERENCE TO RELATED APPLICATIONS

This application claims the benefit under 35 U.S.C. § 119(e) of U.S. Patent Application No. 63/306,598, entitled “Refuse Collection Vehicle,” filed Feb. 4, 2022, which is incorporated herein by reference in its entirety.

### FIELD OF THE DISCLOSURE

This disclosure relates to refuse collection vehicles, and more particularly to electric refuse collection vehicles.

### BACKGROUND OF THE DISCLOSURE

Refuse collection vehicles collect solid waste and transport the solid waste to landfills, recycling centers, or treatment facilities. Refuse collection vehicles that are powered with fossil fuels can have low fuel efficiency and emit relatively high amounts of carbon emissions. Additionally, most refuse collection vehicles use hydraulic systems that require extensive maintenance, can be noisy, consume power at idle, and can leak. These and other shortcomings make refuse collection vehicles excellent targets for system electrification. Methods and equipment for improving refuse collection vehicles are sought.

### SUMMARY

Implementations of the present disclosure include a refuse collection vehicle. The refuse collection vehicle includes a wheeled chassis, a battery pack, a refuse collection body, and a DC-DC converter. The wheeled chassis has an electric propulsion motor connected to a road wheel of the chassis. The battery pack has multiple battery cells and provides electrical power to the propulsion motor. The refuse collection body is carried by the chassis and defines a refuse storage compartment. The refuse collection body includes a refuse packer driven by an electric packer motor. The refuse collection body also includes a powered tailgate driven by an electric tailgate motor. The DC-DC converter is connected to the battery pack and provides electrical power to the electric packer motor and to the electric tailgate motor at one or more DC voltages different than a voltage provided by the battery pack to the DC-DC converter.

In some implementations, the refuse collection vehicle also has multiple motor controllers each operationally coupled to a respective one of the electric packer motor and the electric tailgate motor. The motor controllers control, based on operation command inputs received from an operator, the electric packer motor and the electric tailgate motor. In some implementations, the refuse collection vehicle also includes a power distribution box carried by the wheeled chassis. The power distribution box receives electricity from the DC-DC converter and distributes the electricity to the multiple motor controllers. In some implementations, the multiple motor controllers are secured to a front surface of the refuse collection body. The front surface faces a cabin carried by the wheeled chassis. In some implementations, the motor controllers are disposed in a box comprising a cabinet door comprising a high voltage interlock switch. In some implementations, the DC-DC converter is secured to the front surface of the refuse collection body and disposed vertically above the multiple motor controllers.

In some implementations, the battery pack is secured to a lower frame of the wheeled chassis and disposed between a front wheel and a back wheel of the refuse collection vehicle.

In some implementations, the DC-DC converter receives electricity from the battery pack at a voltage of between 500 V to 1500 V and outputs electricity at a voltage of less than between 90 V and 1200 V.

In some implementations, the refuse collection vehicle also includes a second DC-DC converter electrically connected, in parallel, with the DC-DC converter to provide, with the DC-DC converter, a single output.

In some implementations, the DC-DC converter is secured to an upper surface of a lower frame of the wheeled chassis, the upper surface facing away from the road on which the wheeled chassis is supported.

In some implementations, the DC-DC converter is secured to a surface underneath the refuse collection body, the surface facing the road on which the wheeled chassis is supported. In some implementations, the DC-DC converter is secured to a lower surface of a lower frame of the wheeled chassis.

In some implementations, the DC-DC converter is secured to a bottom surface of the refuse collection body and disposed on a side of a lower frame opposite the battery pack.

In some implementations, the DC-DC converter is secured to a roof of a collection tank of the refuse collection body.

In some implementations, the DC-DC converter is secured to one of an outer surface or an inner surface of the powered tailgate.

In some implementations, the DC-DC converter is secured to a lower frame of the wheeled chassis and disposed between the refuse collection body and a cabin of the refuse collection vehicle.

In some implementations, the refuse collection vehicle also includes a portable, front-load collection basket attached to arms of the refuse collection vehicle and the DC-DC converter is secured to the collection basket.

In some implementations, the refuse collection vehicle also includes a refuse collection basket disposed between the storage compartment and a cab of the refuse collection vehicle, and the DC-DC converter is secured to a front surface of the refuse collection basket facing the cab.

Implementations of the present disclosure also include a refuse collection vehicle that has a wheeled chassis, a refuse storage tank, a battery pack, and a DC-DC converter. The refuse storage tank is carried by the wheeled chassis. The refuse storage tank includes a refuse packer attached to the refuse storage tank and driven by an electric packer actuator. The refuse storage tank also includes a powered tailgate attached to the refuse storage tank and driven by an electric tailgate actuator. The battery pack is carried by the wheeled chassis and has multiple battery cells. The DC-DC converter is carried by the wheeled chassis and is connected to the battery pack. The DC-DC converter provides electrical power to the electric packer actuator and to the electric tailgate actuator at one or more DC voltages different than a voltage provided by the battery pack to the DC-DC converter.

In some implementations, the refuse collection vehicle also includes multiple motor controllers each configured to control electric motors of the electric packer actuator and the electric tailgate actuator to control the electric packer actuator and the electric tailgate actuator.

Implementations of the present disclosure also include a refuse collection vehicle that includes a wheeled chassis, a refuse storage tank, a battery pack, and a DC-DC converter. The refuse storage tank is carried by the wheeled chassis. The refuse storage tank has an electric actuator that drives at least one of a refuse packer attached to the refuse storage tank or a powered tailgate attached to the refuse storage tank. The battery pack is carried by the wheeled chassis and includes a plurality of battery cells. The DC-DC converter is carried by the wheeled chassis and connected to the battery pack. The DC-DC converter provides electrical power to the electric actuator at one or more DC voltages different than a voltage provided by the battery pack to the DC-DC converter.

Particular implementations of the subject matter described in this specification can be implemented so as to realize one or more of the following advantages. For example, the electric refuse collection vehicle of the present disclosure can be configured to utilize commercially available high power actuator motors and motor controllers that operate at different voltages, and at different voltages than a battery pack supplying electric power to other systems, such as a vehicle propulsion system.

### BRIEF DESCRIPTION OF THE DRAWINGS

FIG. 1 is a perspective, schematic view of a refuse collection vehicle according to a first implementation of the present disclosure.

FIG. 2 is a perspective, schematic view of a refuse collection vehicle according to a second implementation of the present disclosure.

FIG. 3 is a bottom perspective, schematic view of a refuse collection vehicle according to a third implementation of the present disclosure.

FIG. 4 is a perspective, schematic view of a refuse collection vehicle according to a fourth implementation of the present disclosure.

FIG. 5 is a perspective, schematic view of a refuse collection vehicle according to a fifth implementation of the present disclosure.

FIG. 6 is a perspective, schematic view of a refuse collection vehicle according to a sixth implementation of the present disclosure.

FIG. 7 is a perspective, schematic view of a part of a refuse collection vehicle according to a seventh implementation of the present disclosure.

FIG. 8 is a block diagram of an electric system of the refuse collection vehicle according to a first implementation of the present disclosure.

FIG. 9 is a block diagram of an electric system of the refuse collection vehicle according to a second implementation of the present disclosure.

FIG. 10 is a schematic illustration of an example control system or controller of the refuse collection vehicle.

### DETAILED DESCRIPTION OF THE DISCLOSURE

The electrical waste collection vehicle of the present disclosure includes electrical actuators that move the various components of the vehicle. The electrical waste collection vehicle of the present disclosure use a DC-DC converter that converts a high DC battery voltage to one or more lower DC voltages selected for compatibility with the various electric motors controlling the electric actuators of the refuse collection vehicle. Unless otherwise specified, when we refer to voltage and current, we are referring to direct current (DC) voltage and current, rather than alternating current (AC) voltage and current.

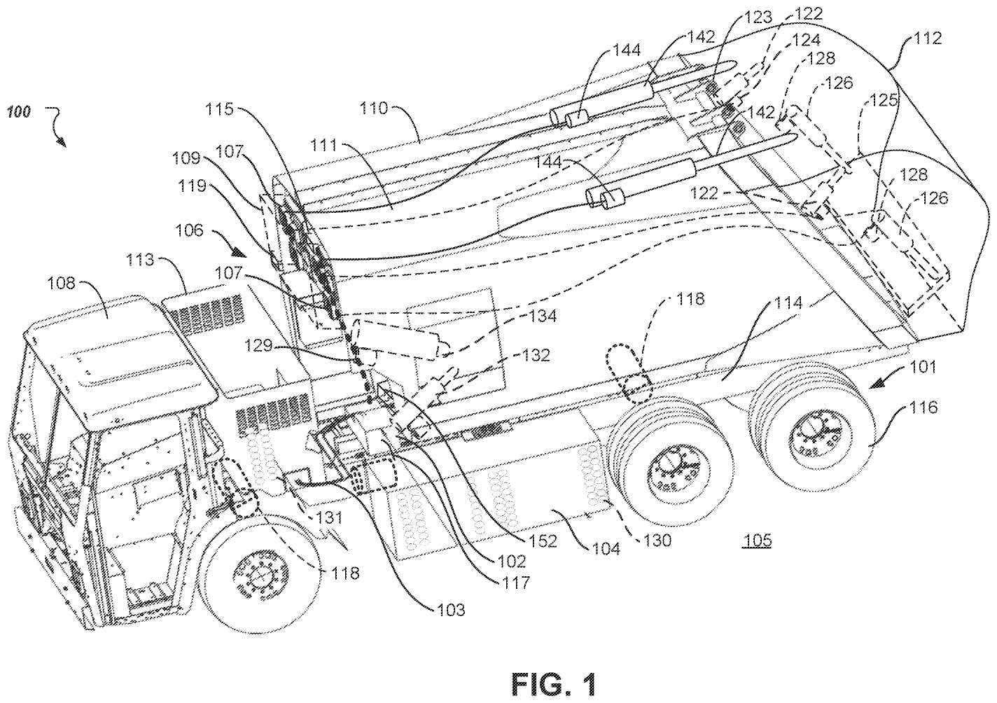

FIG. 1 depicts an electric refuse collection vehicle 100. The refuse collection vehicle 100 is illustrated as a rear loader, but the refuse collection vehicle 100 can be a front loader, a side loader, or another type of refuse collection vehicle such as a skid-loader, a tele-handler, a plow truck, or a boom lift.

The refuse collection vehicle 100 has a wheeled chassis 101. The wheeled chassis 101 includes a lower frame 114 and road wheels 116 attached to the lower frame 114. The refuse collection vehicle 100 also includes a cabin 108 (e.g., a driver's cab) and a refuse collection body 110 carried by the wheeled chassis 101. The refuse collection body 110 defines a refuse storage compartment or tank 111 that stores the waste material collected by the refuse collection vehicle 100. The refuse collection vehicle 100 also includes a battery pack 104, one or more DC-DC converters 102, and a group of motor controllers 106. Additionally, the refuse collection vehicle 100 can include other components associated with electric vehicles such as a battery pack charger, an inverter, sensors, switches, and control systems such as an electric vehicle monitoring system (EVMS) and a battery management system (BMS).

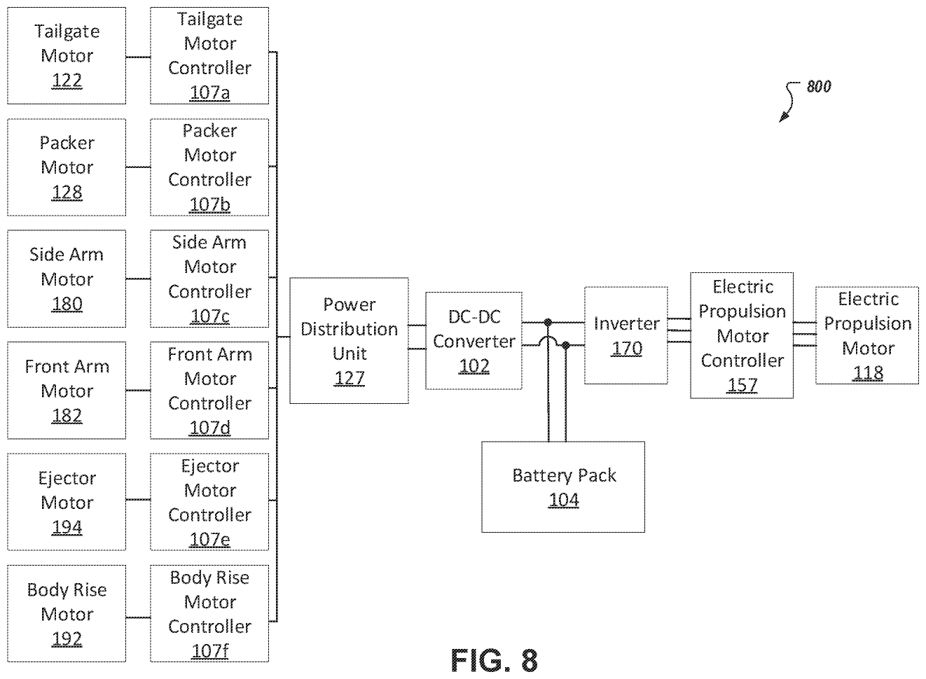

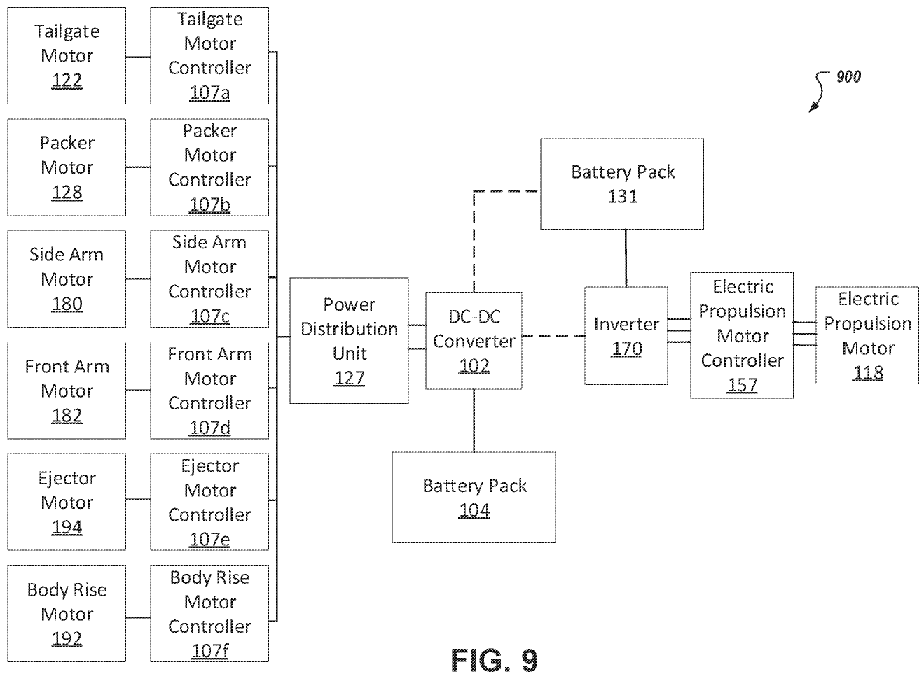

The refuse collection vehicle 100 can be fully electric. For example, the refuse collection vehicle 100 can have electric actuators (instead of hydraulic actuators) and one or more electric propulsion motors 118 connected to one or more wheels 116 of the chassis 101. The electric propulsion motors 118 can be configured, for example and without limitation, as hub motors, belt-drive motors, or mid-drive motors. The electric propulsion motors 118 can be, for example and without limitation, DC series motor, brushless DC motors, permanent magnet synchronous motors (PMSM), AC induction motors (e.g., three-phase AC induction motors), or switched reluctance motors (SRM). As further described in detail below with respect to FIGS. 8-9, one or more battery packs can power the electric actuators and the propulsion motors 118. Additionally, the refuse collection vehicle 100 can have electric actuators but the propulsion can be non-electric (e.g., powered by a diesel or propane engine).

The refuse collection body 110 includes a powered tailgate 112 and a refuse packer 125. The powered tailgate 112 and the refuse packer can be both driven by electric actuators. For example, the powered tailgate 112 is driven by one or more electric tailgate motors 124 of one or more electric actuators 122, and the refuse packer 125 is driven by one or more electric packer motors 128 of one or more electric actuators 126. Additionally, the refuse collection vehicle 100 can have other electrically-powered actuators in place of other typical hydraulic actuators. For example, the refuse collection vehicle 100 can have ejector electric actuators 134, body-raise electric actuators 132, and overhead container lift actuators 142. In the case of front-loader and side-loader vehicles, the arms or forks that lift the trash containers are also powered by electric motors and actuators. In some implementations, part of the body actuation functions could be electric and part could remain hydraulic. For example, instead of being driven by electric actuators 126, the tailgate 112 can be moved by hydraulic actuators. This could be accomplished with a local oil reservoir or with a larger oil reservoir that serving multiple hydraulic actuation points.

Still referring to FIG. 1, each electric tailgate motor 124 is part of or is connected to a respective electric tailgate actuator 122 that is attached to the powered tailgate 112. For example, the electric tailgate motor 124 is attached (e.g., by a gearbox) to the electric tailgate actuator 122 to control, by rotation of a shaft of the motor 124, the electric tailgate actuator 122. The electric actuators of the collection body 110 can be linear actuators or rotary actuators.

The electric tailgate actuator 122 can be, for example and without limitation, a ball screw actuator, a lead screw actuator, or a rotary style electric actuator. For example, the electric tailgate actuator 122 can be a linear actuator from Ewellix, located in Goteborg, Sweden. In the case of a linear actuator, the electric tailgate actuator 122 can push open, by extending an arm of the actuator 122, the powered tailgate 112. Extension of the actuator 122 causes the tailgate 112 to rotate about a pivot 123, opening the refuse storage compartment 111. Thus, the powered tailgate 112 is electrically opened and closed to unload the waste material stored in the refuse storage compartment 111.

Rotary actuator assemblies can include an electric motor that drives a gear reduction “box” which transmits power via a keyed or splined shaft to the electric tailgate or the corresponding component of the vehicle 100. The actuators of the refuse collection body 110 can be custom-made for the specific power, force, speed, and displacement required to move the components of the collection body 110.

The electric tailgate motors 124 can be, for example and without limitation, a DC series motor, a brushless DC motor, a permanent magnet synchronous motor (PMSM), an AC induction motor (e.g., three-phase AC induction motors), or a switched reluctance motor (SRM).

Similar to the electric tailgate motors 124, each electric packer motor 128 is part of or is connected to a respective electric packer actuator 126. Each electric packer actuator 126 is attached to the refuse packer 125 to move the refuse packer 125. The electric packer motor 128 is attached (e.g., by a gearbox) to the electric packer actuator 126 and controls, by rotation of a shaft of the motor 128, the refuse packer 125. The electric packer actuators 126 move the packer 125 to pack the waste material by retracting (or extending) an arm of the actuator 126. The linear electric packer actuators 126 can be similar to the electric tailgate actuators 122 and the electric packer motors 128 can be similar to the electric tailgate motors 124.

The battery pack 104 is secured to the lower frame 114 of the wheeled chassis 101 and is disposed between a front wheel and a back wheel of the refuse collection vehicle 100. The battery pack 104 has multiple battery cells 130 (e.g., lithium-ion battery cells) that provide electrical power to all or part of the electrical components of the refuse collection vehicle 100. For example, the battery pack 104 can provide electrical power to one or more of the propulsion motors 118, the electric tailgate motors 124, the electric packer motors 128, the electric motors of the other electric actuators 132, 134, and 142, and to the electrical components inside the cabin 108.

The refuse collection vehicle 100 can also include a battery housing 113 that stores a chassis battery pack 131 (e.g., a second battery pack). The chassis battery pack 131 can include multiple battery cells (e.g., lithium-ion battery cells) that provide electrical power to the propulsion motors 118, the chassis components, and the cabin 108. For example, the first battery pack 104 can provide electrical power to the electric motors of the actuators of the refuse collection body 110 and the second battery pack 131 can provide electrical power to the electric propulsion motors 118, to the electronic components of the chassis (e.g., headlights and tail lights) and to the electric components of the cabin 108 (e.g., interior lights, navigation, air conditioning, radio, etc.). In some implementations, the refuse collection vehicle 100 can have one battery pack (either the first or second battery pack 104, 131) that powers all of the electrical components of the vehicle 100, or the first battery pack 104 can be the chassis battery pack and the second battery pack 131 can power the electric motors of the collection body 110. The battery packs 104, 131 can be charge with an onboard generator (not shown) that can charge the batteries while the truck is in motion

The converter 102 and the battery packs 102, 131 can have or be coupled to a cooling system (e.g., a direct or indirect liquid cooling system) that keeps the converter 102 and battery cells from overheating. Additionally, the electric actuators (e.g., the actuator motors) can include a dedicated cooling system or be integrated into the cooling system of the converter 102 and the battery packs 102, 131. As described in detail below, the DC-DC converter can be cooled, depending on their location, with different cooling systems such as by using forced or natural air convection, refrigeration systems, or liquid cooling systems. For example, the vehicle 100 can use heat sinks and/or can have air conduits to route air to the converter.

The DC-DC converter 102 is connected to the battery pack 104. The DC-DC converter 102 changes a voltage of the electricity sent from the battery pack 104 to the electric packer motor 128 and to the electric tailgate motor 124 (and to the other actuator motors of the collection body 110). Specifically, the DC-DC converter 102 provides electrical power to the electric packer motor 128 and to the electric tailgate motor 124 at one or more DC voltages different than a voltage provided by the battery pack 104 to the DC-DC converter 102. For example, the DC-DC converter 102 can receive electricity from the battery pack 104 at a voltage of between 500 V to 1500 V (e.g., 656 V). The DC-DC converter 102 lowers the voltage (and outputs electricity) to between 90 V to 1200 V (e.g., 100 V).

The current can significantly increase across the DC-DC converter 102. For example, the DC-DC converter 102 can receive electricity at a current of between 250 A to 700 A (e.g. 675 A) and transmit electricity at a current of between 50 and 450 A (e.g., 300 A). Thus, the electric motors that drive the electric actuators require large amounts of power. Specifically, the electricity transmitted to the motors from the DC-DC converter 102 is at a very high current even at relatively high voltages. Thus, the cabling, safety equipment, and location of the electric equipment is designed and intended to support these high-power motors while maintaining the operators safe. For example, the high-current cable 129 or cables that transmit power from the DC-DC converter 102 to the motor controllers 106 can be 0 gauge or greater, such as 00 gauge or 000 gauge. The cable 129 can be covered by a protective housing or box to prevent the cable 129 from being exposed to an operator.

Additionally, the refuse collection vehicle 100 can have two or more DC-DC converters 152 electrically connected, in parallel, with the first DC-DC converter 102 to provide, with the first DC-DC converter 102, a single output. For example, each DC-DC converter 102, 152 can transmit electricity at the same voltage.

The battery pack 104 can be connected to the DC-DC converter 102 using high-voltage wires (not shown) or a bus bar connection. The high-voltage wires can extend through be attached to or covered underneath the refuse collection body 110 or to another component of the refuse collection vehicle 100.

The DC-DC converter 102 can be located in different strategic parts of the refuse collection vehicle 100. For example, as shown in FIG. 1, the DC-DC converter 102 can be attached to a top surface of the lower frame 114 of the wheeled chassis 101, near the battery packs 104, 131 and near the controllers 106. The top surface of the lower frame 114 faces away from a floor 105 support the vehicle 100. Placing the DC-DC converter 102 near the controllers 106 reduces the length of high current cabling 129, which increases the safety of the refuse collection vehicle 100. The short distance between the DC-DC converter 102 and the battery pack 104 lowers the resistance in the cable, which reduces the power losses across the cabling 117, 103 connecting the battery packs 104, 131 to the DC-DC converter, and reduced the chances of cable bending and failure. Additionally, with the DC-DC converter 102 near the battery packs, a common cooling unit can cool both the battery packs and the converter.

The location of the main electrical components can also improve the weight distribution of the vehicle 100. For example, because the powered tailgate 112 of the rear loader vehicle 100 can be significantly heavy, placing the DC-DC converter 102, the battery packs 104, 121, and the controllers 106 on the opposite side of the powered tailgate 112 can shift the center of gravity of the vehicle lower and toward the center, which can increase the stability, sterility, and overall handling of the vehicle.

The DC-DC converter 102 can be located in other locations of the vehicle 100 such as mounted on the cabin 108, between the collection body 110 and the lower frame 114, or on a side of the lower frame 114. The DC-DC converter 102 can be attached, assembled, or built into the chassis 101 prior to, during, or after mounting the collection body 110 to the chassis 101. Additionally, the DC-DC converter 102 in these locations (and as shown in FIG. 1) is readily accessible for an operator to replace or maintain the unit.

The refuse collection vehicle 100 also has one motor controller 107 or a group of motor controllers 106. The motor controllers 106 can be attached to the front surface of the body 110 facing the back of the cabin 108, above the DC-DC converter 102. Each controller 107 can be associated with a respective electric motor of the vehicle 100. For example, each controller 107 can be operationally coupled to a respective one of the electric packer motors 128, the electric tailgate motor 121, and the motors of the other actuators 132, 134, and 142. The controllers 107 control, based on operation command inputs received from a control system of the cabin 108, the electric packer motors 128, the electric tailgate motor 121, and the motors of the other actuators 132, 134, and 142. For example, a driver can control, using a user interface or other input device inside the cabin 108, the different electric actuators of the refuse collection vehicle 100. In some implementations, the electric actuators can be controlled automatically (e.g., nosed on sensor inputs) or remotely with a computer disposed outside of the vehicle 100.

In some implementations, each controller 107 can be implemented as a distributed computer system. The computer system can include one or more processors and a computer-readable medium storing instructions executable by the one or more processors to perform the operations described here (e.g., control the electric actuators). In some implementations, the controller 107 can be implemented as processing circuitry, firmware, software, or combinations of them. The controller 107 can transmit signals to the multiple electric motors of the electric actuators to move the components of the refuse collection vehicle 100.

In some implementations, the controllers 107 can be covered and protected by a box 109. For example, the controllers 107 can be disposed inside the box 109 which has a cabinet door with a high voltage interlock switch 119. The box can also house all or part of the cable 129. The high voltage interlock switch 119 includes a relay that can cut or disconnect the power between the controllers 107 and the DC-DC converter 102 when the door of actuation is lost. For example, the high voltage interlock switch 119 can disconnect the high voltage when the box 109 is opened or a command is sent based on a fault. The box 109 can be configured as a slidable (or pivotable) panel that can slide out from either side of the vehicle for troubleshooting or maintenance purposes. Additionally, the battery packs 104, 131 and the DC-DC converter 102 can be mounted on slidable panels attached to the chassis and slidable with respect to the chassis from either side the vehicle for troubleshooting or maintenance purposes.

The refuse collection vehicle 100 also includes a power distribution box or unit 115 carried by the wheeled chassis 101. For example, the power distribution unit 115 can be attached to a front surface (e.g., the front head) of the storage compartment 111 adjacent (e.g., next to, above, below, or behind) the controllers 107 and facing the cab. The power distribution unit 115 can also be attached to the curb side (e.g., facing the curb) of the front head. The power distribution unit 115 can receive electricity, through cable 129, from the DC-DC converter 102 and distribute the electricity to the controllers 107. For example, the power distribution unit 115 resides electrically between the DC-DC converter 102 and the group of controllers 106 to receive electricity from the DC-DC converter 102 and transmit electricity to each of the controllers 107.

The cabin 108 includes various components such as seats and a steering wheel. Additionally, the cabin 108 can include controls (e.g., a user interface, switches, buttons, dials, etc.) that receive inputs from an operator (e.g., the driver) to control the electric actuators and other components of the refuse collection vehicle 100.

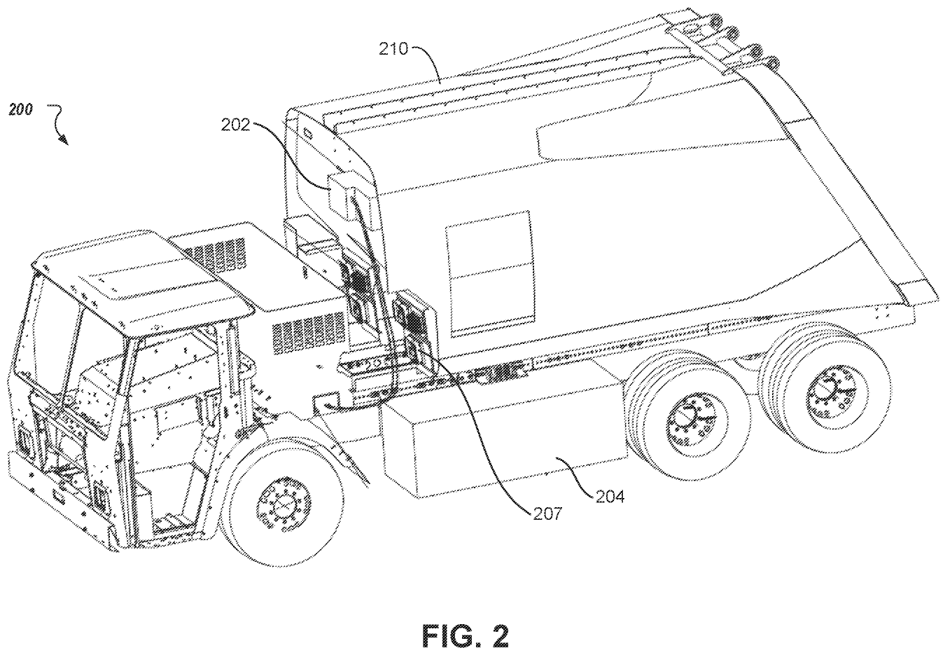

FIG. 2 shows a refuse collection vehicle 200 similar to the refuse collection vehicle 100 of FIG. 1, with the main exception that the refuse collection vehicle 200 has a DC-DC converter 202 attached to the front surface of the refuse collection body 210. For simplicity, the refuse collection vehicle 200 of FIG. 2 does not show the tailgate and other components shown in the refuse collection vehicle 100 of FIG. 1. The refuse collection vehicle 200 has a battery pack 204 that powers the electric components of the refuse collection vehicle 200. The refuse collection vehicle 200 has controllers 207 attached to the front surface of the refuse collection body 110. The DC-DC converter 202 resides vertically above the controllers 207.

The location of the DC-DC converter 202 as shown in FIG. 2 can allow the converter 202 to be cooled entirely or in part by the ambient air flowing by the converter 202. For example, during movement of the vehicle (or during days of high wind speed), the surrounding ambient air can flow at a speed sufficient to cool the DC-DC converter 202 by way of air convection. The DC-DC converter 202 can have apertures or otherwise be partially exposed to allow air to flow through the DC-DC converter 202. The DC-DC converter 202 can also be cooled with forced air, and can have other cooling equipment such as cooling fans, heat exchangers, liquid cooling conduits, heat sinks, or thermosiphons. The DC-DC converter can be placed in a different location such as on top of the collection body 210 where the converter is exposed to ambient air to help cool the converter.

Additionally, similar to the location of the DC-DC converter 102 of FIG. 1, the DC-DC converter 202 is relatively close to the battery packs and the controllers such that the cabling (and any cooling lines, if needed) are short, reducing power losses and increases the safety of the electrical wiring. Furthermore, the location of the DC-DC converter 202 and the other electrical components can improve the weight distribution of the vehicle 200 by lowering and shifting the center of gravity of the vehicle away from the tailgate (not shown) of the vehicle 200. The DC-DC converter 102 is also readily accessible for an operator to replace or maintain the unit.

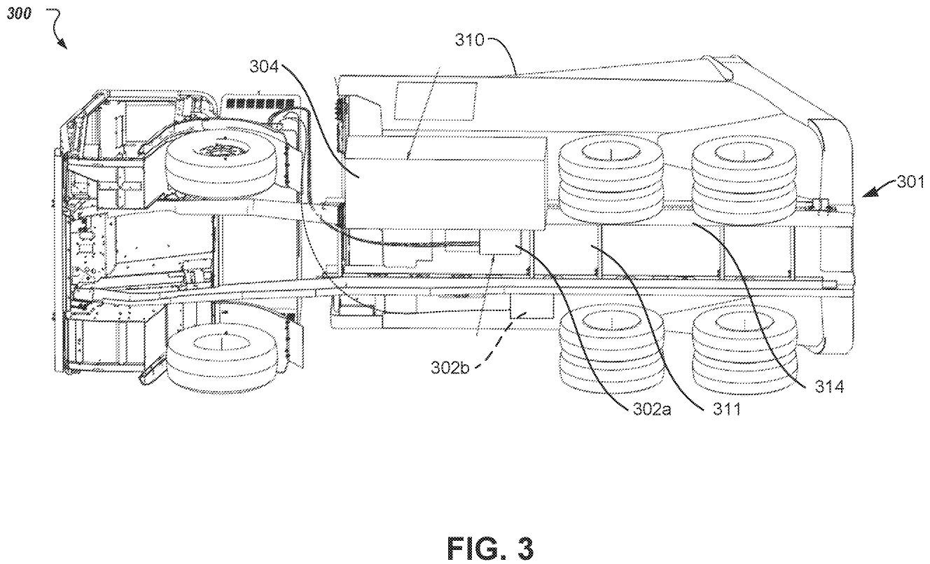

FIG. 3 illustrates a refuse collection vehicle 300 similar to the refuse collection vehicle 100 of FIG. 1, with the main exception that the refuse collection vehicle 300 has a DC-DC converter 302a that resides below the refuse collection body 310. For example, the DC-DC converter 302a can be secured to a surface that faces the road on which the refuse collection vehicle 100 is supported. Specifically, the DC-DC converter 302a can be secured to a bottom surface 311 of the lower frame 314 of the wheeled chassis 301. As shown in dotted lines, the DC-DC converter 302b (or an additional DC-DC converter) can also be secured to a bottom surface of the refuse collection body 310 opposite the battery pack 304. The DC-DC converter can also be attached to a side surface (e.g., a surface facing the curb) of the lower frame 314.

The two locations of the DC-DC converter 302a (or 302b) as shown in FIG. 3 can allow the converter 202 to be cooled entirely or in part by the ambient air flowing by the converter 202. Additionally, similar to the location of the DC-DC converter 102 of FIG. 1, the DC-DC converter 302a (or 302b) is relatively close to the battery packs, reducing power losses across the cables and increases the safety of the electrical wiring. Furthermore, the location of the DC-DC converter 302a (or 302b) can help improve the weight distribution of the vehicle 300 by lowering and shifting the center of gravity of the vehicle away from the tailgate (not shown) of the vehicle 300. Additionally, placing the DC-DC converter 302a (or 302b) below the vehicle 300 can help protect the converter from the sun and other elements, which can help keep the converter cool and in good condition.

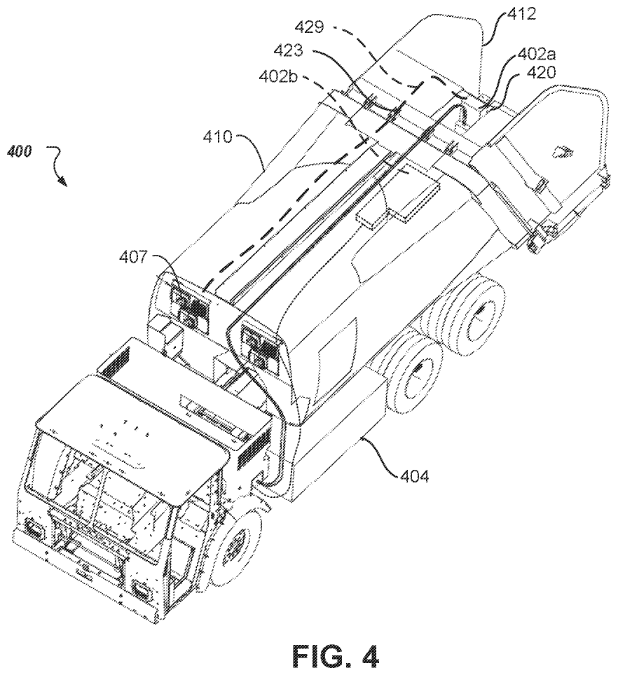

FIG. 4 depicts a rear loader refuse collection vehicle 400 similar to the refuse collection vehicle 100 of FIG. 1, with the main exception that the refuse collection vehicle 400 has a DC-DC converter 402a that is secured to the powered tailgate 412 of the refuse collection vehicle 400. For example, as shown in FIG. 4, the DC-DC converter 402a can be disposed inside a housing 420 of the tailgate 412. In some implementations, the DC-DC converter 402a can be attached to an external surface of the tailgate 412. As shown in dotted lines, the DC-DC converter 402b (or an additional DC-DC converter) can also be secured to a top surface (e.g., a roof) of the refuse collection body 410 of the vehicle 400.

Placing the DC-DC converter 402a at the tailgate as shown in FIG. 2 reduces the distance between the DC-DC converter 402a and the electric actuators in or near the tailgate 412. The reduced distance decreases the cable lengths and cooling lines between the converter and the actuators (which can increase safety and reliability) and can allow the use of a common cooling system. Placing the DC-DC converter 402b can have similar advantages. Additionally, the location of the DC-DC converter 402b on top of the collection body 410 allows the converter 402b to be cooled entirely or in part by the ambient air flowing through the converter 402b. Furthermore, the vehicle 400 can have air channels or be shaped to route air to the converter when the converter is not fully exposed to ambient air. For example, the housing 420 can be open at the top and bottom of the housing to allow for air circulation. In the case of the converter being under the collection body 410 (see FIG. 3), the converter can be placed along a fluid pathway of the ambient air when the vehicle is in motion, and air can be routed from the sides toward the converter.

Still referring to FIG. 4, similar to the power cable 129 shown in FIG. 1, the power cable 429 that connects the DC-DC converter 402a to the controllers 407 can be a thick cable (e.g., 0 gauge or even 00 gauge or 000 gauge). The cable 429 can be covered by a protective housing or sleeve to prevent the cable 129 from being exposed to an operator. Because the cable 429 can be difficult to bend, the cable 429 can be routed over or along a tailgate hinge 423 to prevent the cable 429 from flexing often and to control how much the cable 429 bends. The cables powering the electric motors disposed in the tailgate (e.g., the tailgate motors and the packer motors) can be similar cables and can similarly be routed along the hinge 423.

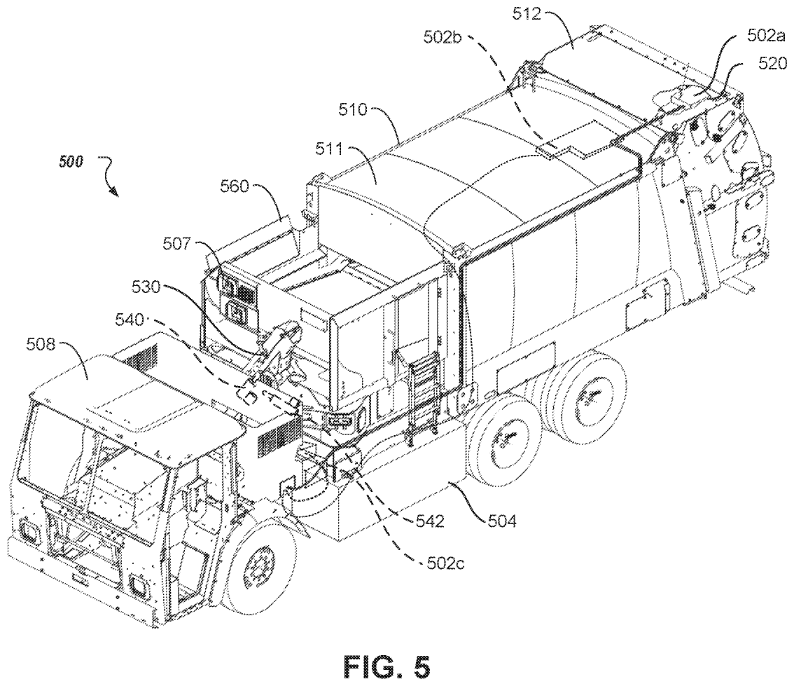

FIG. 5 shows a side-loader refuse collection vehicle 500. The side-loader refuse collection vehicle 500 has a robotic arm 530 that is moved by electric actuators 540, 542. The electric actuators can include, for example, an arm lift electric actuator 540 and an arm reach electric actuator 542. Each electric actuator 540, 542 can be moved, similar to the electric actuators of FIG. 1, by a respective electric motor coupled to the actuators 540, 542 and powered by the battery pack 504. The robotic arm 530 can dump the waste material inside a basket 560 disposed between the storage compartment 511 and the cabin of the refuse collection vehicle 500.

Similar to the refuse collection vehicles 100, 200, 300, 400 described in FIGS. 1-4, the side-loader refuse collection vehicle 500 has a DC-DC converter that can be positioned at the tailgate 512, on top of the storage compartment 511, below the storage compartment 511, or between the storage compartment 511 and the cabin 508 of the refuse collection vehicle 500. Specifically, the DC-DC converter 502a can be disposed inside a housing 520 of the tailgate 512. In some implementations, the DC-DC converter 502a can be attached to an external surface of the tailgate 512. As shown in dotted lines, the DC-DC converter 502b (or an additional DC-DC converter) can also be secured to a top surface (e.g., a roof) of the refuse collection body 510 of the vehicle 500. Also as shown in dotted lines, the DC-DC converter 502c (or an additional DC-DC converter) can be attached to the lower frame of the vehicle between the basket 560 and the cabin 508 of the side-loader refuse collection vehicle 500. The controllers 507 can be attached to the front surface of the basket 560. The locations of the DC-DC converters 502a, 502b, 502c have different advantages as described above with respect to FIGS. 1-5. For example, the DC-DC converters 502a, 502b disposed near the tailgate can be cooled with a common cooling system cooling the electric tailgate actuators, and the DC-DC converter 502c disposed near the battery packs reduces the distance of the high-voltage cabling between the battery packs and the converter, and makes the converter 502c accessible for maintenance purposes.

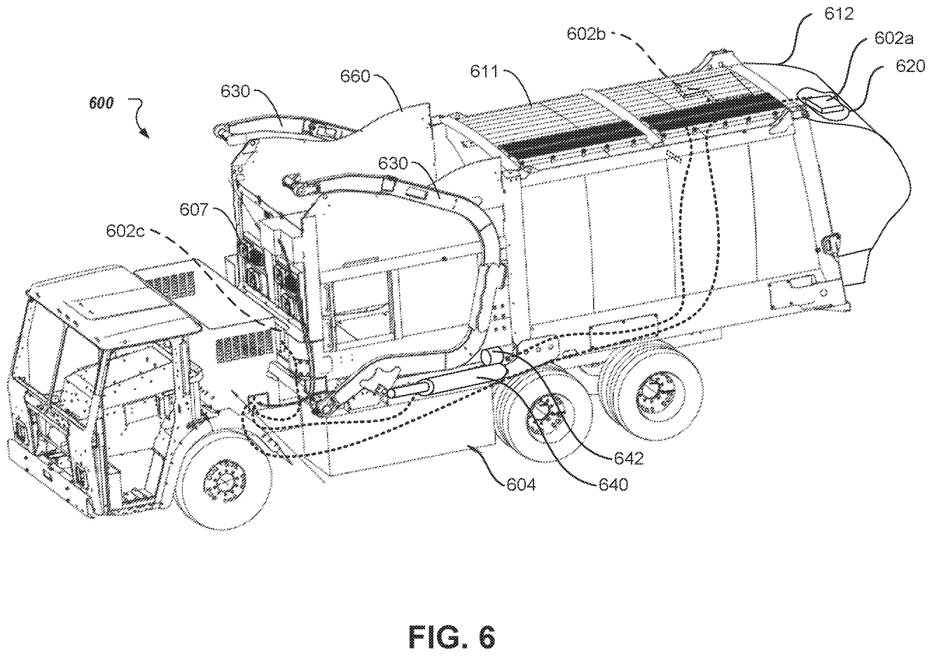

FIG. 6 shows a front-loader refuse collection vehicle 600. The front-loader refuse collection vehicle 600 has two robotic arms or lifts 630. Each arm 630 is moved by a respective electric actuators 640. Each electric actuator 640 is moved, similar to the electric actuators of FIG. 1, by a respective electric motor 642 coupled to the actuator 640 and powered by the battery pack 604. The arms 630 lift a waste container and dump the waste material from the container to a basket 660 disposed between the storage compartment 611 and the cabin of the refuse collection vehicle 600.

Similar to the refuse collection vehicles 100, 200, 300, 400, 5050 described in FIGS. 1-5, the front-loader refuse collection vehicle 600 has a DC-DC converter that can be positioned at the tailgate 612, on top of the storage compartment 611, below the storage compartment 611, or between the storage compartment 611 and the cabin of the refuse collection vehicle 600. Specifically, as shown in FIG. 6, the DC-DC converter 602a can be disposed inside a housing 620 of the tailgate 312. In some implementations, the DC-DC converter 602a can be attached to an external surface of the tailgate 612. As shown in dotted lines, the DC-DC converter 602a (or an additional DC-DC converter 602b) can also be secured to a top surface (e.g., a roof) of the refuse collection body 610 of the vehicle 600. Also as shown in dotted lines, the DC-DC converter 602a (or an additional DC-DC converter 602c) can be attached to a front surface of the basket 630 between the basket 660 and the cabin of the front-loader refuse collection vehicle 600. The controllers 607 can be attached to the front surface of the basket 660. The locations of the DC-DC converters 602a, 602b, 602c have different advantages as described above with respect to FIGS. 1-5. For example, the DC-DC converters 602a, 602b disposed near the tailgate can be cooled with a common cooling system cooling the electric tailgate actuators, and the DC-DC converter 602c disposed near the battery packs reduces the distance of the high-voltage cabling between the battery packs and the converter, and makes the converter 602c accessible for maintenance purposes. Additionally, for front loader and rear loader vehicles, placing the DC-DC converter at or near the tailgate can help shift the center of gravity away from the front axle (or from the side) of the vehicle toward the tailgate, which can increase the stability, sterility, and overall handling of the vehicle.

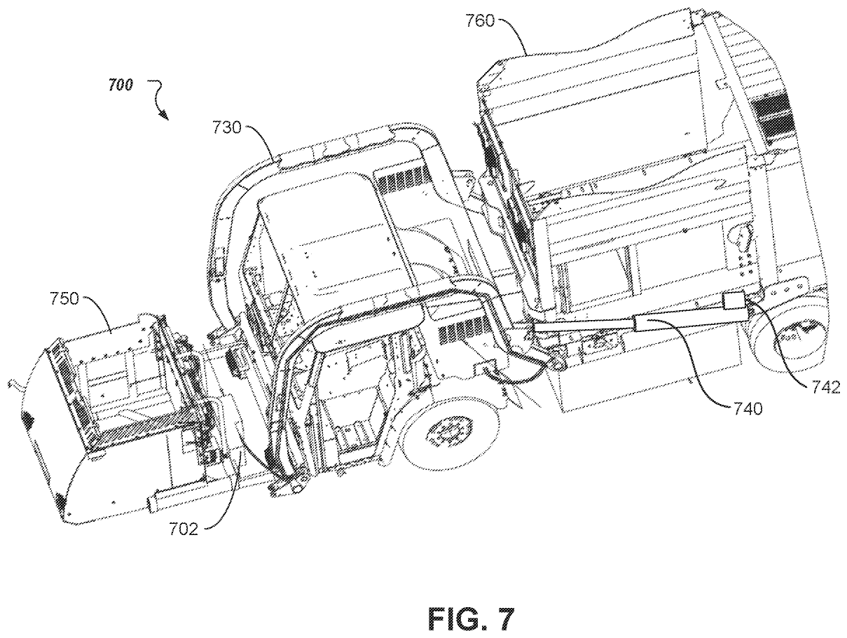

FIG. 7 shows a front-loader refuse collection vehicle 700 similar to the front-loader refuse collection vehicle 600 in FIG. 7, with the main exception that the front-loader refuse collection vehicle 700 has a portable collection basket 750. The DC-DC controller 702 can be attached to a back surface of the portable collection basket 750. High voltage cables supply DC power from the battery pack to the DC-DC controller. Electrical disconnects may be provided at the portable collection basket to electrically disconnect the DC-DC controller and the basket-mounted electrical actuators and motor controllers from the supply voltage to remove the basket when not in use. The location of the DC-DC-converter 702 can allow the converter to be fully or partially cooled with ambient air (e.g., by natural or forced convection cooling) and allows the converter 702 to be accessible for maintenance purposes.

FIG. 8 shows a block diagram of an example electric system 800 of a refuse collection vehicle (e.g., any of the refuse collection vehicles illustrated in FIGS. 1-7). The electric system 800 includes the battery pack 104, an inverter 170, an electric propulsion motor controller 157, an electric propulsion motor 118, a DC-DC converter 102, a power distribution unit 127, multiple controllers 107a-107f, and multiple electric motors 124, 128, 180, 182, 192, 194. The battery pack 104 is electrically connected and provides power to the propulsion motor 118 and to the multiple electric motors 124, 128, 180, 182, 192, 194 associated with the electric actuators of the refuse collection body.

The inverter 170 can be used when the electric propulsion motor 118 is an AC motor. The inverter 170 received DC electricity from the battery pack 104 and outputs AC electricity to the electric propulsion motor 118. If the electric propulsion motor 118 is DC motor. The battery pack can directly transmit electricity to the electric propulsion motor controller 157 without the inverter 170.

The DC-DC converter 102 lowers the voltage of the electricity received from the battery pack 104 and transmits the electricity at a lower voltage to the power distribution unit 127. The power distribution unit 127 distributes the power to the multiple controllers 107a-107f which control a respective electric motor.

FIG. 9 shows a block diagram of an electric system 900 of a refuse collection vehicle (e.g., any of the refuse collection vehicles illustrated in FIGS. 1-7). The electric system 900 includes two separate battery packs 104 and 131. In some implementations, the electric system 900 can include more than two battery packs. The first battery pack 104 powers the multiple electric motors 124, 128, 180, 182, 192, 194 associated with the electric actuators of the refuse collection body. The second battery pack 131 powers the electric propulsion motor 118 and other electrical components of the vehicle. The second battery pack 131 can optionally be electrically connected to the DC-DC converter 102 and the DC-DC converter 102 can be electrically connected to the inverter 170 to transmit electricity to the inverter 170 at a different voltage than the voltage of the battery pack 131. In some implementations, the waste collection vehicle can be powered by fossil fuels, such that the first battery pack 104 powers the multiple electric motors 124, 128, 180, 182, 192, 194 and the vehicle is propelled by an engine instead of an electric propulsion motor.

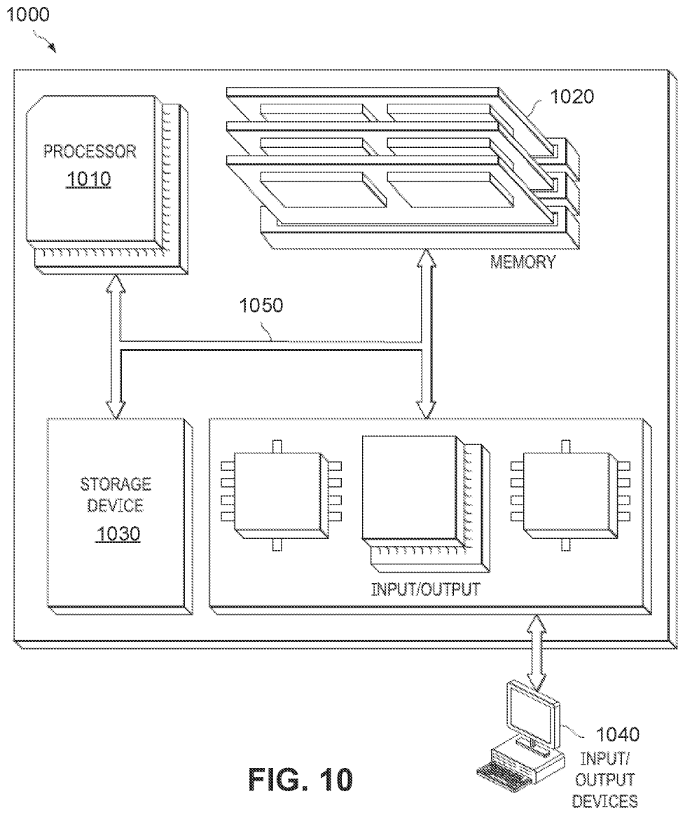

FIG. 10 is a schematic illustration of an example control system or controller for a waste collection vehicle according to the present disclosure. For example, the controller 1000 may include or be part of the controllers 107 shown in FIGS. 1-9. The controller 1000 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the controller 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the controller 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the controller 1000. In one implementation, the storage device 1030 is a computer-readable medium. In various different implementations, the storage device 1030 may be a floppy disk device, a hard disk device, an optical disk device, or a tape device.

The input/output device 1040 provides input/output operations for the controller 1000. In one implementation, the input/output device 1040 includes a keyboard and/or pointing device. In another implementation, the input/output device 1040 includes a display unit for displaying graphical user interfaces.

Although the following detailed description contains many specific details for purposes of illustration, it is understood that one of ordinary skill in the art will appreciate that many examples, variations and alterations to the following details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a”, “an” and “the” include plural referents, unless the context clearly dictates otherwise.

As used in the present disclosure and in the appended claims, the words “comprise,” “has,” and “include” and all grammatical variations thereof are each intended to have an open, non-limiting meaning that does not exclude additional elements or steps.

As used in the present disclosure, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present disclosure.

What is claimed is:

1. A refuse collection vehicle, comprising:
a wheeled chassis with an electric propulsion motor connected to a road wheel of the chassis;
a battery pack comprising multiple battery cells and configured to provide electrical power to the propulsion motor;
a refuse collection body carried by the chassis and defining a refuse storage compartment, the refuse collection body comprising:
a refuse packer driven by an electric packer motor; and
a powered tailgate driven by an electric tailgate motor; and
a DC-DC converter connected to the battery pack and configured to provide electrical power to the electric packer motor and to the electric tailgate motor at one or more DC voltages different than a voltage provided by the battery pack to the DC-DC converter.

2. The refuse collection vehicle of claim 1, further comprising multiple motor controllers each operationally coupled to a respective one of the electric packer motor and the electric tailgate motor, the multiple motor controllers configured to control, based on operation command inputs received from an operator, the electric packer motor and the electric tailgate motor.

3. The refuse collection vehicle of claim 2, further comprising a power distribution box carried by the wheeled chassis and configured to receive electricity from the DC-DC converter and distribute the electricity to the multiple motor controllers.

4. The refuse collection vehicle of claim 2, wherein the motor controllers are disposed in a box comprising a cabinet door comprising a high voltage interlock switch.

5. The refuse collection vehicle of claim 2, wherein the multiple motor controllers are secured to a front surface of the refuse collection body, the front surface facing a cabin carried by the wheeled chassis.

6. The refuse collection vehicle of claim 5, wherein the DC-DC converter is secured to the front surface of the refuse collection body and disposed vertically above the multiple motor controllers.

7. The refuse collection vehicle of claim 1, wherein the battery pack is secured to a lower frame of the wheeled chassis and disposed between a front wheel and a back wheel of the refuse collection vehicle.

8. The refuse collection vehicle of claim 1, wherein the DC-DC converter is configured to receive electricity from the battery pack at a voltage of between 500 V to 1500 V and output electricity at a voltage of less than between 90 V and 1200 V.

9. The refuse collection vehicle of claim 1, further comprising a second DC-DC converter electrically connected, in parallel, with the DC-DC converter to provide, with the DC-DC converter, a single output.

10. The refuse collection vehicle of claim 1, wherein the DC-DC converter is secured to an upper surface of a lower frame of the wheeled chassis, the upper surface facing away from the road on which the wheeled chassis is supported.

11. The refuse collection vehicle of claim 1, wherein the DC-DC converter is secured to a surface underneath the refuse collection body, the surface facing the road on which the wheeled chassis is supported.

12. The refuse collection vehicle of claim 11, wherein the DC-DC converter is secured to a lower surface of a lower frame of the wheeled chassis.

13. The refuse collection vehicle of claim 11, wherein the DC-DC converter is secured to a bottom surface of the refuse collection body and disposed on a side of a lower frame opposite the battery pack.

14. The refuse collection vehicle of claim 1, wherein the DC-DC converter is secured to a roof of a collection tank of the refuse collection body.

15. The refuse collection vehicle of claim 1, wherein the DC-DC converter is secured to one of an outer surface or an inner surface of the powered tailgate.

16. The refuse collection vehicle of claim 1, wherein the DC-DC converter is secured to a lower frame of the wheeled chassis and disposed between the refuse collection body and a cabin of the refuse collection vehicle.

17. The refuse collection vehicle of claim 1, wherein the refuse collection vehicle further comprises a portable, front-load collection basket attached to arms of the refuse collection vehicle and the DC-DC converter is secured to the collection basket.

18. The refuse collection vehicle of claim 1, wherein the refuse collection vehicle further comprises a refuse collection basket disposed between the storage compartment and a cab of the refuse collection vehicle, and the DC-DC converter is secured to a front surface of the refuse collection basket facing the cab.

19. A refuse collection vehicle, comprising:
a wheeled chassis;
a refuse storage tank carried by the wheeled chassis, the refuse storage tank comprising,
a refuse packer attached to the refuse storage tank and driven by an electric packer actuator, and
a powered tailgate attached to the refuse storage tank and driven by an electric tailgate actuator;
a battery pack carried by the wheeled chassis and comprising a plurality of battery cells; and
a DC-DC converter carried by the wheeled chassis and connected to the battery pack, the DC-DC converter configured to provide electrical power to the electric packer actuator and to the electric tailgate actuator at one or more DC voltages different than a voltage provided by the battery pack to the DC-DC converter.

20. A refuse collection vehicle, comprising:
a wheeled chassis;
a refuse storage tank carried by the wheeled chassis, the refuse storage tank comprising an electric actuator configured to drive at least one of a refuse packer attached to the refuse storage tank or a powered tailgate attached to the refuse storage tank;
a battery pack carried by the wheeled chassis and comprising a plurality of battery cells; and
a DC-DC converter carried by the wheeled chassis and connected to the battery pack, the DC-DC converter configured to provide electrical power to the electric actuator at one or more DC voltages different than a voltage provided by the battery pack to the DC-DC converter.
